(19) United States
(12) Patent Application Publication
(10) Pub. No.: US 2005/0192814 A1
(43) Pub. Date: Sep. 1, 2005

(54) Browser URL and content preloading based on autonomic collaboration

(75) Inventors: David Carroll Challener, Raleigh, NC (US); Michael T. Vanover, Raleigh, NC (US)

Correspondence Address: IBM CORPORATION, PO BOX 12195, DEPT YXSA, BLDG 002, RESEARCH TRIANGLE PARK, NC, 27709, US

(73) Assignee: International Business Machines Corporation, Armonk, NY (US)

(21) Appl. No.: 10/778,873

(22) Filed: Feb. 13, 2004

(51) Int. Cl. G06F 17/60

(52) U.S. Cl. 705/1

(57) ABSTRACT

In a LAN environment, which provides access for multiple users to the Internet, clients (predictors) are selected for identifying Internet content, by their requests, which would be of interest to a larger audience, and then this content is “pushed down” to the caches of an audience of clients. In so selecting content there is a recognition of a shared intellectual direction (e.g. a joint effort) that exists to encourage interest in similar material. This cache “library” is particularly directed to mobile users who work unconnected at times and may lack the time or background to select and pre-load the library.

### BACKGROUND OF THE INVENTION

1. Technical Field

The present invention relates in general to accessing Web pages and in particular to accessing Web pages in environments including multiple users. Still more particularly, the present invention relates to forced caching of Web pages among multiple users for offline use.

2. Description of the Related Art

The Internet has become a cultural fixture as a source of both information and entertainment. Many businesses are creating Web sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state.

Currently, the most commonly employed method of transferring data over the Internet is to employ the World Wide Web environment, also called simply “the Web.” Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling transfer of various data files (e.g., text, still graphic images, audio, motion video, etc.). Information is formatted for presentation to a user by a standard page description language, the Hypertext Markup Language (HTML). In additional to basic presentation formatting, HTML allows developers to specify “links” to other Web resources, identified by a Uniform Resource Locator (URL). An URL is a special syntax identifier defining a communications path to specific information. Each logical block of information accessible to a client, called a “page,” is identified by an URL.

Retrieval of information on the Web is generally accomplished with an HTML-compatible “browser”—a program capable of submitting a request for information identified by an URL—at the client machine. The request is submitted to a server connected to the client and may be handled by a series of servers to effect retrieval of the requested information. The information is provided to the client formatted according to HTML.

One feature of Web browsers which would be particularly advantageous to implement in connection with Web appliances is off-line browsing. Large traffic demands to specific Web sites can make access to such sites difficult. Off-line browsing allows information at the site to be retrieved during or without contemporaneous user interaction at the client for subsequent off-line viewing by the user. Where project workers often work at home or offsite off-line viewing is especially time efficient. Off-line browsing involves viewing Web pages cached in a local memory, such as a hard drive, without connection to the Web site from which those pages originate.

Typically, a scheduling utility allows a user to retrieve specific Web pages for storage on the user's hard drive and later viewing. It would be desirable to provide an automatic and more efficient feature for downloading information from Internet sites to specific groups of users.

### SUMMARY OF THE INVENTION

The present invention recognizes that, although the Internet is a useful and often essential information source, the desired information may be hard to locate, and may take considerable precious time to select and download. Moreover, if the user is working with a mobile system and has time to work when unconnected to the Internet, the desired resources may be unavailable. In some cases a user, say a newcomer to a work group, may need to explore the area of interest and be unsure of where to start.

To address these needs, the invention focuses on the common situation where a group of users on a network share a mission or intellectual direction. According to the invention, predictor users are selected, which by their Internet activity, identify content for an audience which may be all or part of the group of users identified with the mission. The content requested to be downloaded by the predictors is preferably filtered to remove excursions obviously unrelated to the effort. In one implementation, the predictors are enabled to specify material to be “unrelated.”

Hence, as the predictors expand their exploration to move the mission forward, their paths are preserved, according to the invention, by broadcasting the content they download to the audience of users. This content cumulatively provides a library of information to the audience.

By so receiving broadcast content, a user from the audience may explore new areas relevant to the effort even when unconnected, for example in an airport, without having to prepare by guessing at needed material. Indeed, the user may proceed into totally unexpected areas following in the “footsteps” of the predictors. And, a predictor that has explored part of the puzzle may, nonetheless, be able to explore other areas following the footsteps of other predictors by participating in the audience.

This approach also saves Internet access time by broadcasting material of likely common interest over the network.

### DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts a distributed data processing system in which the present invention may be implemented;

FIG. 2 is a block diagram of the major components of data processing unit which may be implemented as a user unit in accordance with a preferred embodiment of the present invention;

FIG. 3 is a table specifying team or effort clients having network access to the Internet and their participation as predictors and audience in accordance with a preferred embodiment of the present invention;

FIG. 4 depicts a high level flowchart for a process for selecting content based on predictor users and broadcasting it to addresses of an audience to develop a library of content on clients of audience users;

FIG. 5 is a block diagram for explaining a browser program suitable for caching content at a client so as to create a library for an audience participant in the group in accordance with a preferred embodiment of the present invention; and

FIG. 6 is a table indicating identities and related content characteristics for members of a project group, according to a preferred embodiment for the present invention.

### DESCRIPTION OF THE PREFERRED EMBODIMENT(S)

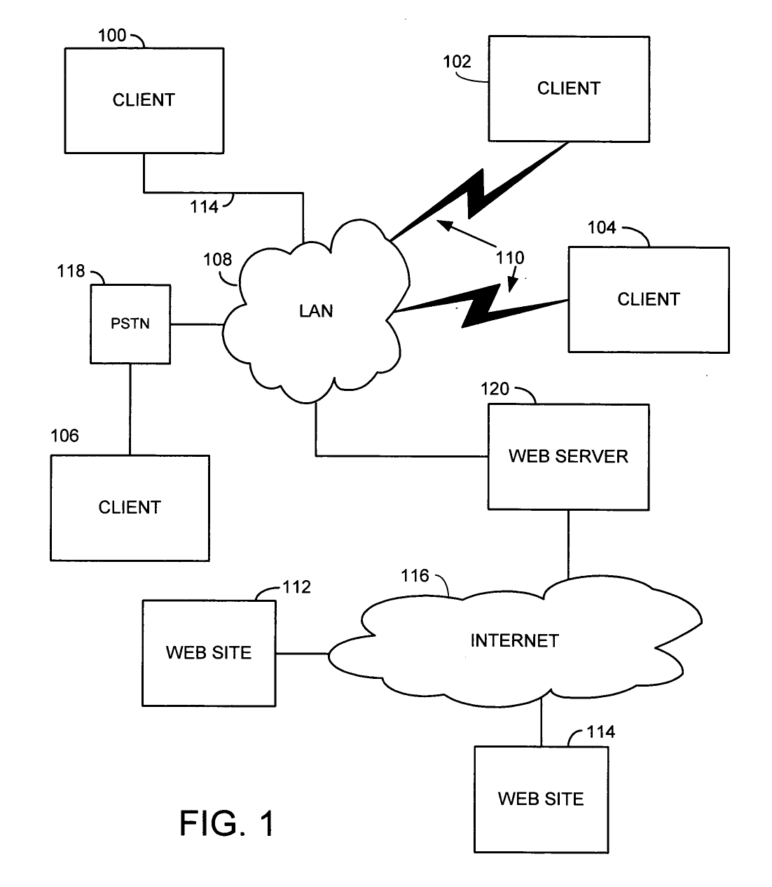

With reference now to the figures, and in particular with reference to FIG. 1, a pictorial representation of a distributed data processing system in which the present invention may be implemented is depicted. Client 100 connects to LAN 108 directly, for example by a wired ethernet connection. Clients 102, and 104 communicate in wireless environment 110 to LAN 108. Client 106 is connected by public switched telephone network (PSTN) 118 to LAN 108. Attached to the LAN 108 is an Web server 120 that provides access to the Internet 116 and processes Internet communications including information requests from clients. The Internet 116 provides access to web sites such as web sites 112 and 114.

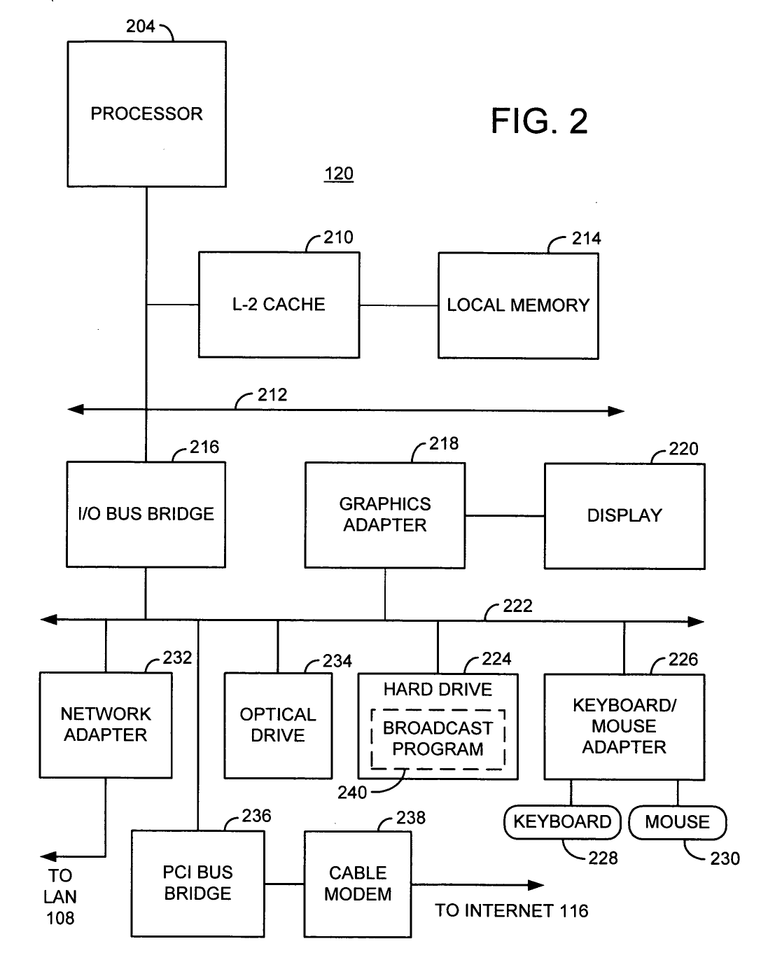

Referring to FIG. 2, a block diagram of a data processing system which may be implemented as a server, such as server 120 in FIG. 1, is depicted. Data processing system 120 includes one or more processors 204 connected to a system bus 212. Also connected to system bus 212 is memory controller/cache 210, which provides an interface to local memory 214. I/O bus bridge 216 is connected to system bus 212 and provides an interface to I/O bus 222.

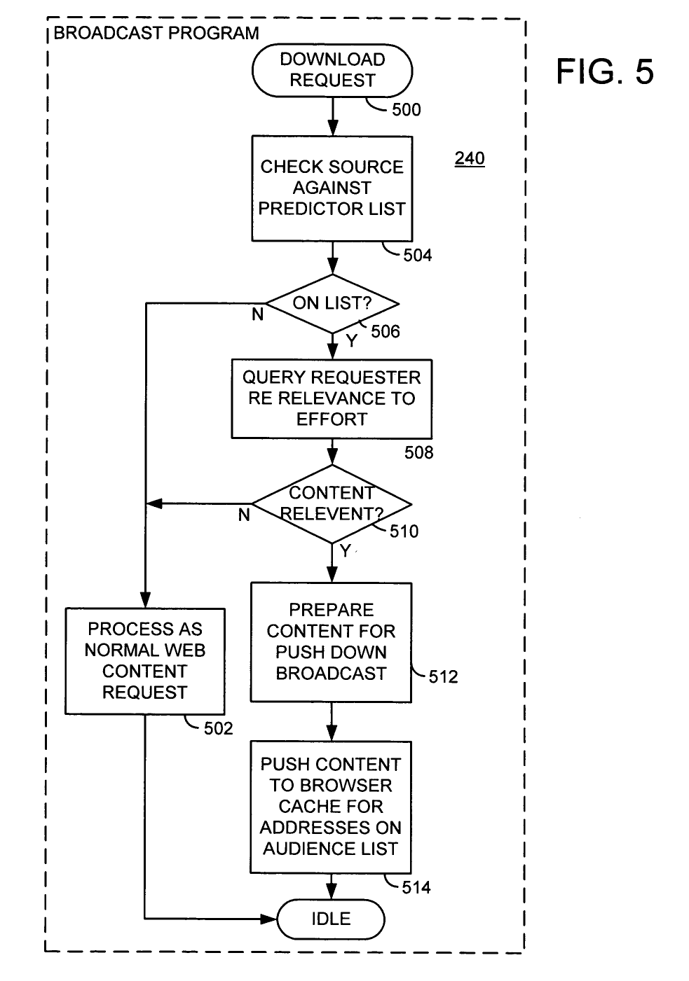

Peripheral component interconnect (PCI) bus bridge 236 is connected to I/O bus 222 provides an interface to PCI bus 206. A cable modem 238 connected to bus 206 supports multiple channels for connection to the Internet. A Network or LAN adapter 232 allows the web server 120 to connect with users client systems to provide Internet access. A memory mapped graphics adapter 230 is connected to the system bus 212 to support display 220. A hard disk 224 is connected to I/O bus 222 and according to the invention has stored therein a broadcast program 240 to be discussed in more detail below with respect to FIG. 5. An optical drive 234 and a keyboard/mouse adapter 226 (supporting keyboard 228 and mouse 230) may also be connected to the I/O bus 222.

Those of ordinary skill in the art will appreciate that the hardware depicted in FIG. 2 may vary and still function as a web server. The depicted example is not meant to imply architectural limitations with respect to the present invention.

The server data processing system in accordance with a preferred embodiment of the present invention includes a Web server program, such as Netscape Enterprise Server Version 2.0, a product of Netscape Communications Corporation in Mountain View, Calif., which supports interface extensions. The server thus contains a known set of server application functions (SAFs) which accept a client's request together with configuration information and returns a response. The server may also include an Application Programming Interface (API) providing extensions enabling application developers to extend or customize the SAFs through software programs commonly known as “plugins.” The server supports off-line browsing by clients and provides storage for pre-caching Web pages. The server also implements and/or supports the processes described below for selecting Web pages for downloading by clients.

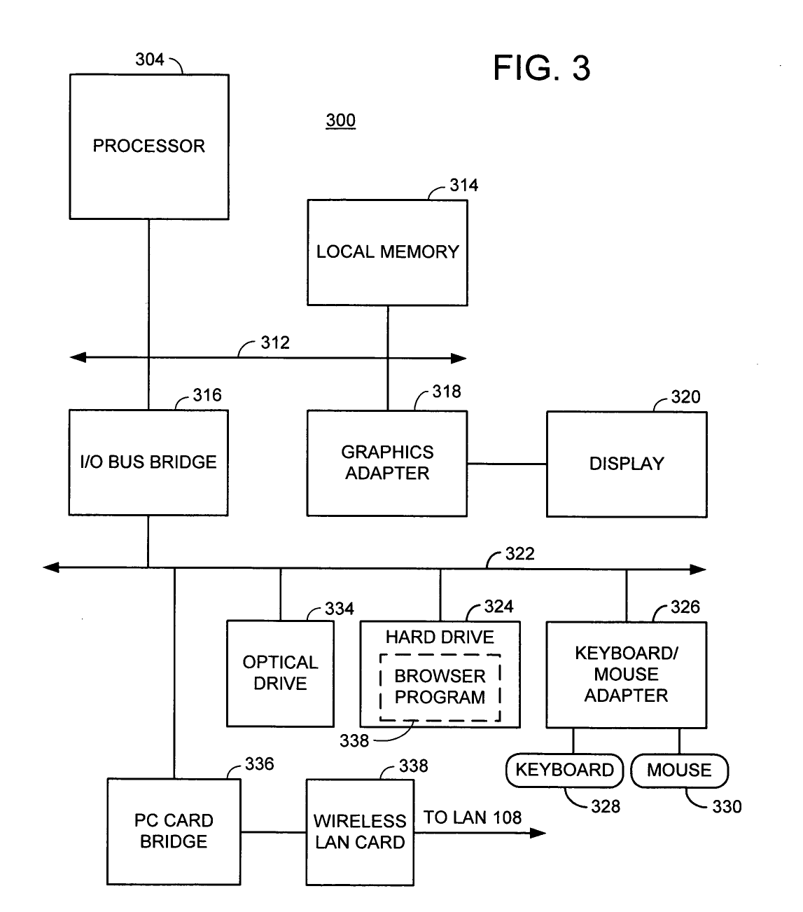

Referring to FIG. 3, a block diagram of a data processing system which may be implemented as a client (100,102,104 or 106) for a user according to the invention. server, such as client 102 in FIG. 1, is depicted. Client data processing system 102 includes one or more processors 304 connected to a system bus 312. Also connected to system bus 312 is memory 314. I/O bus bridge 316 is connected to system bus 312 and provides an interface to I/O bus 322.

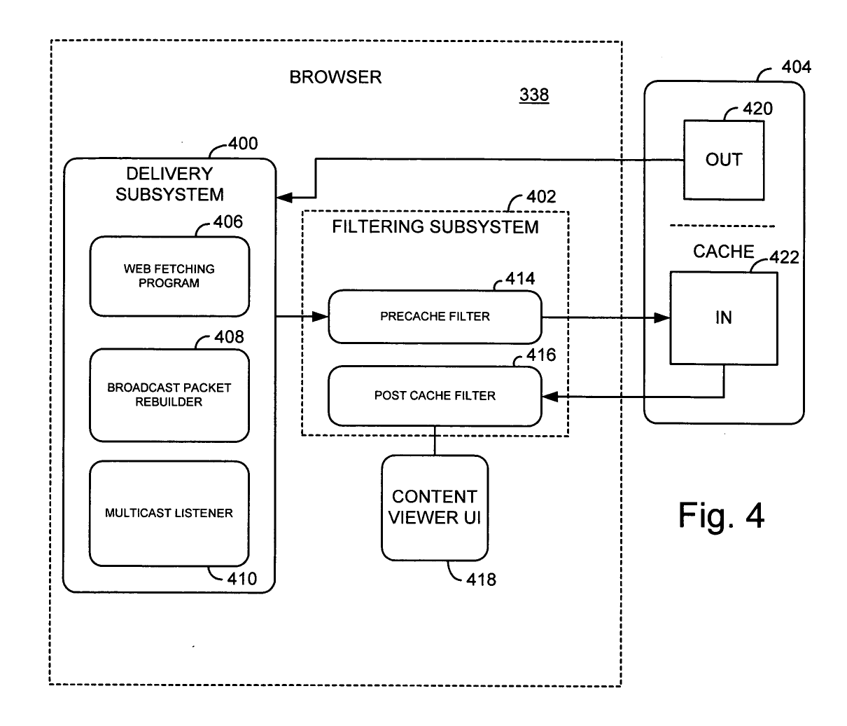

PC Card bridge 336 receives a wireless LAN card which supports connection to LAN 108 (FIG. 1) and is connected to I/O bus 322. A memory mapped graphics adapter 318 is connected to the system bus 312 to support display 320. A hard disk 324 is connected to I/O bus 322 and according to the invention has stored therein a browser program 338 to be discussed in more detail below with respect to FIG. 4. An optical drive 334 and a keyboard/mouse adapter 326 (supporting keyboard 328 and mouse 330) are also be connected to the I/O bus 322.

Again it will be appreciated that variations are possible within the scope of the invention. For example, client 100 (FIG. 1) is direct wired to the LAN 108 and client 106 is connected over a telephone line.

FIG. 4 is a high level block diagram for a client browser 338. The delivery subsystem 400 includes a web fetching program, for requesting content from the Internet 116, a broadcast packet rebuilder 408 for decompressing broadcast content; and a multicast listener 410 for detecting broadcasts from the web server 120. The content is preferably processed by a filtering system 402 to remove content that is irrelevant for user specific reasons. A pre-cache filter 414, for example, might remove information outside the users expertise and a post-cache filter 416 might remove content that is too old. The cache 404, as is known for browsers has an in basket 422 and an out basket 420. Data from the post-cache filter 416 is processed for viewing by a content viewer user interface module 418. These functions are normally available with an Internet browser such as Microsoft's Internet Explorer.

FIG. 5 is a high level flow chart indicating logic flow for a broadcasting system and method 240 according to the invention. When an Internet download request is received (500) it is checked (504) to determine if the requestor is on the predictor list. If not (506) the request is processed normally (502). If so (506), the request is checked (508) for relevance to the effort. Preferable the requester characterizes the request as a part os sending the request. If not relevant (510), the request is processed normally (502). If relevant (510) the logic prepares the content for broadcast (512), for example, by compressing it. The content is then “pushed down” to all addresses on the audience list and that of the requester if not on the audience list (514). This process, according to the invention creates a library of content at the clients that is relevant to the effort of the group.

This creation of a library is especially useful for offline use for a mobile client as the user need not take special action to have the information available.

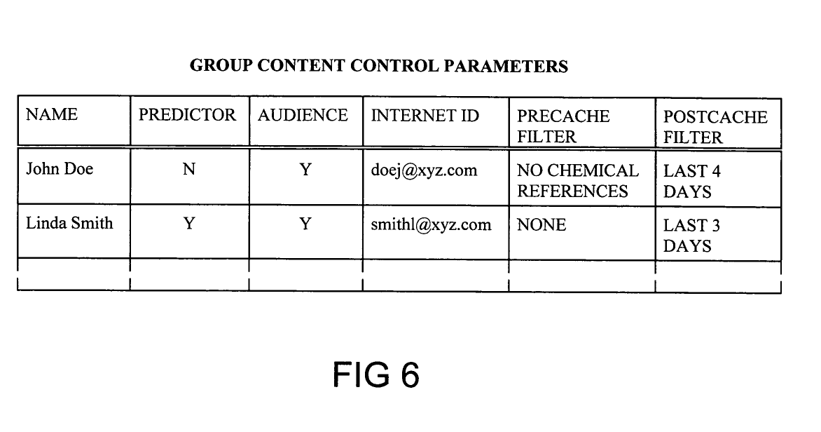

FIG. 6 is a table indicating characteristics for a work group connected to the Internet, their addresses and their status as predictors and audience members for use in controlling the transfer of content according to the logic of FIG. 5. Also indicated are filter selection for browser control according to the logic of FIG. 4.

While the invention has been particularly shown and described with reference to a preferred embodiment, it will be understood by those skilled in the art that various changes in form and detail may be made therein without departing from the spirit and scope of the invention.

1. A method of loading Internet content onto the computer of a user belonging to a group of users connected over a network providing Internet access and working on a common project, said method comprising:
identifying a set of members of the group as predictor users;
identifying a set of members of the group as audience users;
monitoring the Internet requests of the set predictor users; and
broadcasting the content resulting from the requests of the set of predictor users to the computers of the set of audience users.

2. The method according to claim 1 wherein all users of the group are identified as predictor users and audience users.

3. The method of claim 1 wherein at least one of the computers of the set of audience users includes filter logic preventing preselected categories of content from being loaded thereon.

4. The method of claim 1 wherein the content is broadcast to reside in a browser cache of the respective audience user computers.

5. The method of claim 4 wherein at least one of the computers of the set of audience users includes filter logic which deletes content after a preselected period of time.

6. The method of claim 1 wherein the identifying and monitoring occur at an Internet server connected to the computers of the predictor and audience users by a network.

7. The method of claim 6 wherein the Internet server is connected to the Internet and retrieves content in response to requests from a predictor user and directs the content to the requesting predictor user computer and to the audience user computers.

8. Apparatus comprising:
a plurality of user systems;
an Internet server connected to retrieve content from the Internet in response to requests from user systems;
a network connecting the user systems with the Internet server to support transfer of requests and content therebetween;
stored data at said Internet server identifying a group of user systems as a common interest set thereof, identifying preselected user systems of the set as predictor systems and preselected user systems of the set as audience systems;
logic residing in said Internet server for identifying requests for content from the predictor systems and broadcasting the content to the audience systems.

9. Apparatus according to claim 8 wherein the content is broadcast to be retained in a cache of an Internet browser of the respective audience systems.

10. Apparatus according to claim 9 wherein the audience systems have cache logic which filters the content to discard broadcast content having preselected characteristics.

11. A product comprising:
a computer usable medium having computer readable program code stored therein, the computer readable program code in said product being effective to:
identify user systems connected to an Internet server;
receive data identifying user systems into sets of predictor and audience user systems;
monitor Internet content requests from the predictor user systems; and
initiate the broadcast of content requested by predictor user systems to audience user systems.

12. A product according to claim 11 wherein the code is effective to initiate broadcast of the content to respective browser caches of the audience user systems.

13. A product according to claim 11 wherein the sets of predictor and audience user systems both include all the user systems of a preselected group.

14. The product according to claim 11 wherein the code is intended to be executed on an Internet server, which is connected to communicate with the Internet and to download content therefrom and is connected to user systems through a local area network.
